(19) United States
(12) Patent Application Publication
(10) Pub. No.: US 2026/0078226 A1
(43) Pub. Date: Mar. 19, 2026

(54) HIGH TEMPERATURE GEL PROCESSED INSULATION COMPOSITE AND ARTICLES MADE THEREFROM

(71) Applicant: W. L. Gore & Associates, Inc., Newark, DE (US)

(72) Inventors: Paul A. Bielewicz, Newark, DE (US); Edward T. Neitzel, Newark, DE (US); Edward A. Rubin, Newark, DE (US); Tyler Schneider, North East, MD (US)

(73) Assignee: W. L. Gore & Associates, Inc., Newark, DE (US)

(21) Appl. No.: 19/400,707

(22) Filed: Nov. 25, 2025

Related U.S. Application Data
(63) Continuation of application No. PCT/US2024/046098, filed on Sep. 11, 2024.
(60) Provisional application No. 63/583,413, filed on Sep. 18, 2023.

(51) Int. Cl. C08J 3/09; C08K 3/36; H01M 10/658

(52) U.S. Cl. CPC C08J 3/092; C08K 3/36; H01M 10/658; C08J 2323/06

(57) ABSTRACT

High temperature insulative composites that include a gel processed polymer matrix, insulative particles, and additional components are disclosed. In some embodiments, the high temperature insulative composite includes less than 35 wt % of a gel processed polymer matrix, more than 40 wt % insulative particles, and less than 35 wt % other materials. The additional materials include, but are not limited to, an opacifier, an antioxidant, reinforcement fiber(s), and combinations thereof. Also, the insulative composites have at least one of an average maximum temperature less than about 250° C., a z-strength of at least about 25 N, and a compressibility less than about 35% at 1 MPa. The high temperature insulative composites may be formed into thin, strong shapes, thereby facilitating the ability to fabricate shaped materials suitable for a target application. The insulative composite functions as a protective heat propagation barrier when subjected to a temperature above 300° C.

### CROSS-REFERENCE TO RELATED APPLICATION

This application is a continuation of PCT Application No. PCT/US2024/046098, internationally filed on Sep. 11, 2024, which claims the benefit of provisional Application No. 63/583,413, filed Sep. 18, 2023, which are herein incorporated by reference in their entireties for all purposes.

### FIELD

The present disclosure relates generally to gel processed thermally insulative materials, and more specifically, to flexible, thin high temperature insulation composites and articles made therefrom that have excellent mechanical properties and are able to maintain insulative and thermal barrier properties when exposed to high temperatures.

### BACKGROUND

Certain applications, such as battery cell packs, may benefit from using high temperature insulative materials that can also function as a high temperature insulative composite capable of withstanding very high temperatures, such as a thermal runaway event in a lithium-ion battery. However, many conventional insulative materials are difficult to handle, are difficult to form into a desired shape or thickness suitable for the intended application, and/or they may suffer from excessive dusting.

Various protective articles require insulative materials that are thin, strong, compressible, and have insulative properties (e.g., a thermal conductivity sufficient for the intended use). However, some insulative materials are used in applications or devices where a high temperature event may occur, such as when a component within the device malfunctions and releases an amount of energy sufficient to trigger an adverse event (e.g., a thermal runaway event). The resulting temperature increase could potentially damage other components within or external to the device. In some embodiments, a high temperature event may be sufficient to damage a second component, wherein damage to the second component may trigger a second high temperature event (for example, adjacent cells within a high energy battery (e.g., a lithium-ion battery).

Thus, there remains a need for a high temperature insulative composite that is suitable for use in high temperature applications.

### SUMMARY

According to one aspect, (“Aspect 1”), an insulative composite includes greater than about 50 wt % of insulative particles; less than about 35 wt % of a gel processed polymer matrix; and less than about 35 wt % of a combined total of additional components, wherein the weight percent is based on the total weight of the final insulative composite, and wherein the insulative composite has at least one of an average maximum temperature less than about 250° C., a Z-strength greater than about 25 N, and a compressibility less than about 35% at 1 MPa.

According to another aspect, (“Aspect 2”), the insulative composite of Aspect 1, wherein the insulative particles are selected from fumed silica, amorphous silica, colloidal silica, precipitated silica, fused silica, silica gel, silica xerogel, aerogels, silica aerogels, silicates, fumed metal oxides, and combinations thereof.

According to another aspect, (“Aspect 3”), the insulative composite of Aspect 1 or Aspect 2, wherein the insulative particles are fumed silica particles.

According to another aspect, (“Aspect 4”), the insulative composite of any one of the preceding Aspects, wherein the insulative particles include greater than about 70 wt % of the insulative composite.

According to another aspect, (“Aspect 5”), the insulative composite of any one of the preceding Aspects, wherein the gel processed polymer matrix includes a gel processed polymer selected from polyethylene, polypropylene, ethylene-propylene copolymers, polyoxymethylene, polyethylene oxide, polyamides, polyethyleneterephthalate, polyacrylonitrile, polyvinylalcohol, polyhydroxyalkanoates (PHAs), polylactic acid (PLA), and polyvinylidenefluoride.

According to another aspect, (“Aspect 6”), the insulative composite of any one of the preceding Aspects, wherein the gel processed polymer matrix includes a gel processed polyethylene (PE) having a number average molecular weight greater than about 500,000 g/mol.

According to another aspect, (“Aspect 7”), the insulative composite of any one of the preceding Aspects, wherein the gel processed polymer matrix include less than about 20 wt % of the insulative composite.

According to another aspect, (“Aspect 8”), the insulative composite of any one of the preceding Aspects, wherein the insulative composite is non-particulating.

According to another aspect, (“Aspect 9”), the insulative composite of any one of the preceding Aspects, wherein a total of the additional components include one or more opacifier, one or more antioxidant, one or more reinforcement fiber, or any combination thereof.

According to another aspect, (“Aspect 10”), the insulative composite of Aspect 9, wherein the opacifier is selected from carbon black, titanium dioxide, aluminum oxide, zirconium dioxide, iron oxides, silicon carbide, molybdenum silicide, manganese oxide, a polydialkylsiloxane where the alkyl groups contain 1 to 7 carbon atoms, or any combination thereof.

According to another aspect, (“Aspect 11”), the insulative composite of any one of the preceding Aspects, wherein a total of the additional components includes less than about 20 wt % of the insulative composite.

According to another aspect, (“Aspect 12”), the insulative composite of any one of the preceding Aspects, wherein the gel processed polymer matrix includes a blend of at least two different number average molecular weights of the gel processed polymer.

According to another aspect, (“Aspect 13”), the insulative composite of any one of the preceding Aspects, wherein the insulative composite is in the form of an extruded profile, extruded article, injection molded shape, or injection molded article.

According to another aspect, (“Aspect 14”), the insulative composite of any one of the preceding Aspects, including at least one support layer directly bonded thereto.

According to another aspect, (“Aspect 15”), the insulative composite of any one of the preceding Aspects, wherein the insulative particles and additional components are present through a thickness thereof.

According to another aspect, (“Aspect 16”), the insulative composite of any one of the preceding Aspects, wherein particulate components are present through a thickness thereof.

According to another aspect, (“Aspect 17”), an article includes the insulative composite of any one of Aspects 1-16.

According to another aspect, (“Aspect 18”), Aspect 18 includes use of the insulative composite of any one of Aspects 1 to 16 to prevent thermal propagation within a lithium-ion battery.

According to another aspect, (“Aspect 19”), a multilayer article includes at least two layers of the insulative composite of any one of Aspects 1 to 16.

According to another aspect, (“Aspect 20”), the multilayer article of 19, wherein the at least two layers each include different components therein.

According to another aspect, (“Aspect 21”), an article includes a first component capable of a generating a high temperature event including a first temperature; a second component to be protected against exposure to the first temperature; and an insulative composite positioned between the first element and the second element, the insulative composite having a first side oriented toward the first component and an opposing side oriented towards the second component; the insulative composite including: greater than about 50 wt % of insulative particles; less than about 35 wt % of a gel processed polymer matrix; and less than about 35 wt % of a combined total of additional particulate components, wherein the weight percent is based on the total weight of the final insulative composite, and wherein the insulative composite includes at least one of an average maximum temperature less than about 250° C., a Z-strength of at least about 25 N, and a compressibility of 35% at 1 MPa.

According to another aspect, (“Aspect 22”), the article of Aspect 21, wherein the temperature on an external side of the second component is less than 250° C. at 50 kPa compression.

According to another aspect, (“Aspect 23”), the insulative composite of Aspect 21 or Aspect 22, wherein the gel processed polymer matrix includes a gel processed polymer selected from polyethylene, polypropylene, ethylene-propylene copolymers, polyoxymethylene, polyethylene oxide, polyamides, polyethyleneterephthalate, polyacrylonitrile, polyvinylalcohol, polyhydroxyalkanoates (PHAs), polylactic acid (PLA), and polyvinylidenefluoride.

According to another aspect, (“Aspect 24”), the insulative composite of any one of Aspects 21-23, wherein the gel processed polymer matrix includes less than about 20 wt % of the insulative composite.

According to another aspect, (“Aspect 25”), the article of any one of Aspects 21-24, wherein the gel processed polymer matrix includes an expanded gel processed polyethylene (PE) having a number average molecular weight greater than 500,000 g/mol.

According to another aspect, (“Aspect 26”), the article of any one of Aspects 21-25, wherein the gel processed polymer matrix includes a blend of at least two different number average molecular weights of the gel processed polymer.

According to another aspect, (“Aspect 27”), the article of any one of Aspects 21-26, wherein the insulative particles are selected from fumed silica, amorphous silica, colloidal silica, precipitated silica, fused silica, silica gel, silica xerogel, aerogels, silica aerogels, silicates, fumed metal oxides, and combinations thereof.

According to another aspect, (“Aspect 28”), the article of any one of Aspects 21-27, wherein the insulative particles include greater than about 70 wt % of the insulative composite.

According to another aspect, (“Aspect 29”), the article of any one of Aspects 21-28, wherein the additional particulate components include one or more opacifier, one or more antioxidant, one or more reinforcement fiber or any combination thereof.

According to another aspect, (“Aspect 30”), the insulative composite of any one of Aspects 21-29, wherein a total of the additional particulate components includes less than about 20 wt % of the insulative composite.

According to another aspect, (“Aspect 31”), the article of any one of Aspects 21-30, wherein the article has a thickness less than about 25 mm.

According to another aspect, (“Aspect 32”), the article of any one of the Aspects 21-30, wherein the article prevents thermal propagation in a lithium-ion battery.

According to another aspect, (“Aspect 33”), the article of any one of the Aspects 21-30, including a support layer directly bonded to the insulative composite.

According to another aspect, (“Aspect 34”), Aspect 34 includes use of the article of any one of Aspects 21-30 to prevent thermal propagation within a lithium-ion battery.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1A is a schematic cross-section of a high temperature insulative composite having therein varying particulate components through a thickness thereof in accordance with some embodiments;

FIG. 1B is a schematic cross-section of a multi-layer high temperature insulative composite having therein differing particulate size distributions in different layers in accordance with some embodiments;

FIG. 2 is a schematic illustration of the testing system used to evaluate the performance of samples in the Protective Heat Propagation Barrier Testing in accordance with some embodiments;

FIG. 3 is a graphical illustration of a representative plot of the heat accumulator temperature and the temperature measured on the opposing sides of the composite insulation sample over test duration in accordance with some embodiments;

FIG. 4 is a scanning electron micrograph (SEM) of a cross-section of a gel processed insulative composite showing opacifier particles distributed throughout the gel processed insulative composite in accordance with some embodiments;

FIG. 5 is a blown-up view of the scanning electron micrograph (SEM) of FIG. 4 in accordance with some embodiments;

FIG. 6 is a graphical illustration of the compressibility of the gel processed insulative composite of Example 1 and the non-gel processed insulative composite of Comparative Example 1.

### DETAILED DESCRIPTION

This disclosure is not meant to be read in a restrictive manner. For example, the terminology used in the application should be read broadly in the context of the meaning those in the field would attribute such terminology. Persons skilled in the art will readily appreciate that various aspects of the present disclosure can be realized by any number of methods and apparatus configured to perform the intended functions. It should also be noted that the accompanying figures referred to herein are not necessarily drawn to scale and may be exaggerated to illustrate various aspects of the present disclosure, and in that regard, the figures should not be construed as limiting.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. In the event it is determined that individuals having ordinary skill in the relevant arts would not readily ascertain values for such reasonably small differences, the terms “about” and “approximately” can be understood to mean plus or minus 10% of the stated value.

It is to be understood that the terms “high temperature insulative composite”, “insulative composite”, and “high temperature gel processed insulative composite” may be used interchangeably herein. In addition, the terms “thermally insulative particles” and “insulative particles” may be interchangeably used herein. Further, the terms “other components” and “additional components” may be interchangeably used herein.

### Definitions

As used herein, the singular forms “a”, “an”, and “the” include plural reference unless the context clearly dictates otherwise.

The term “on” as used herein is meant to denote that when an element is “on” another element, it can be directly on the other element or intervening elements may also be present.

The term “high temperature gel processed insulative composite” refers to an insulative composite that includes a gel processed polymer matrix and which functions as a protective heat propagation barrier when subjected to a transient temperature above 300° C.

As used herein, “gel processed polymer matrix” refers to a polymer having been formed by a gel process and specifically excludes any polymer formed by paste processing. In one embodiment, the gel process polymer matrix refers to gel processed polymer matrix formed from a polymer selected from polyethylene, ultra-high molecular weight polyethylene (UHMWPE), polypropylene, ethylene-propylene copolymers, polyoxymethylene, polyethylene oxide, polyamides, polyethyleneterephthalate, polyacrylonitrile, polyvinylalcohol, polyhydroxyalkanoates (PHAs), polylactic acid (PLA), and polyvinylidenefluoride. In another embodiment, the gel processed polymer matrix refers to a gel processed polymer matrix formed form gel processed polyethylene. In a further embodiment, the gel processed polymer matrix refers to a gel processed polymer matrix formed from gel processed UHMWPE.

The term “gel processed polyethylene” refers to an ultra-high molecular weight polyethylene (UHMWPE) formed by a gel process, and which has a number average molecular weight of at least about 200,000 g/mol, at least about 500,000 g/mol, at least about 1,000,000 g/mol, at least about 5,000,000 g/mol, at least about 7,000,000, or at least about 10,000,000 g/mol.

The terms “weight percent” or “wt %” are meant to denote the weight percent of that component based on the total weight percent of the final high temperature insulative composite (i.e., after diluent is removed). “Wt %” may be defined as the mass of the component divided by the total mass of the high temperature gel processed insulative component (after diluent is removed) multiplied by 100.

As used herein, the term “high temperature event” is intended to describe a situation where a temperature is generated sufficient to at least partially or fully decompose the polymeric material within the gel processed polymer matrix. In one aspect, the high temperature event is an event where a temperature of at least about 500° C. is achieved. In a further aspect, the high temperature event is an event where a temperature of at least 500° C. to about 1200° C. is achieved.

As used herein, “additional components” include opacifier(s), antioxidant(s), reinforcement fiber(s), and/or other particulate or non-particulate components, and combinations thereof.

The term “average maximum temperature” is meant to denote the temperature on the protected side in accordance with the Protective Heat Propagation Barrier Testing Assay described herein.

The term “non-particulating” as used herein is intended to describe the lack of particulate and/or non-particulate components (e.g., material) shedding or otherwise falling off the insulative composite during assembly or in use.

### High Temperature Gel Processed Insulative Composites

The high temperature gel processed insulative composites of the present disclosure include a gel processed polymer matrix, insulative particles, and additional components (e.g., one or more opacifier, one or more antioxidant, reinforcement fiber(s), and/or other particulate or non-particulate components, as well as combinations thereof). In some embodiments, the high temperature insulative composite includes less than 35 wt % of a gel processed polymer matrix, more than 40 wt % insulative particles, and less than 35 wt % additional components. As set forth above, the term weight percent (wt %) is the percent of the total weight of the high temperature gel processed insulative composite. It is to be appreciated that the total wt % of all of the components that form the gel processed insulative composite equals 100 wt %. Additionally, the high temperature gel processed insulative composite may be formed into thin, flexible shapes, thereby facilitating the ability to fabricate shaped materials suitable for a target application. The gel processed insulative composite functions as a protective heat propagation barrier when subjected to a transient temperature above 300° C.

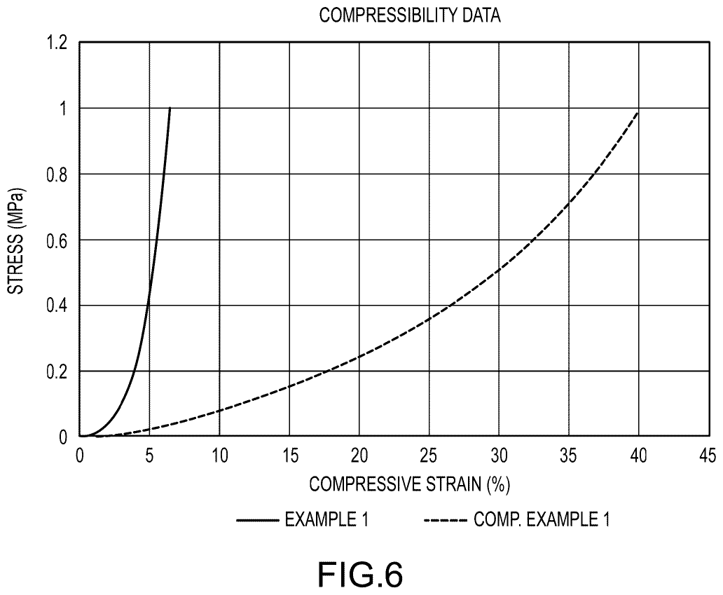

The insulative composite is suitable for use in lithium-ion battery applications and/or in articles that have at least one thermally sensitive component that is capable (generally upon failure of that component) of releasing energy that results in a transient temperature greater than about 300° C. Lithium-ion batteries are formed of a plurality of individual lithium-ion battery cells placed adjacent to each other. In normal operation, lithium-ion batteries swell over time. In lithium-ion battery modules, where the lithium-ion battery cells are placed adjacent to each other, the swelling can impart a pressure or stress on materials placed between adjacent cells. This stress can be in excess of 1 MPa, depending on the design of the lithium-ion battery cells and the module in which they are placed, and is a factor that should be considered when developing an insulative composite to be placed between the cells to mitigate or even prevent a thermal runaway. The pressure exerted on conventional insulation material positioned between the cells can reduce the thickness of the insulation material, thereby resulting in a reduction in both thermal resistance and the potential to mitigate a thermal runaway. It is therefore important to create an insulative composite that may be placed between the lithium-ion battery cells which has very low compressibility (e.g., less than 35% compressible at 1 MPa). FIG. 6 is a graphical illustration of the compressibility of the gel processed insulative composite (Example 1) and a non-gel processed insulative composite described in Comparative Example 1.

In addition, the insulative composite has strength in the z-direction. The need for z-strength arises from the desire for the insulating materials to be easily handled in a high automated production environment. In order for the electrification of vehicles to have a global impact on the reduction of CO₂, the vehicles need to be efficient at a massive scale, which is only possible using automation. The desire to automate creates new challenges in the design of materials that may be used in an automated process. The materials need to be able to handle the dynamic forces of high throughput automation. Such dynamic forces can be challenging for insulating materials because insulating materials are often fragile because of their low densities resulting from the high air content in them. The fragility of the insulting materials can be managed to some extent in the planar dimension of the insulation material with the use of cover layers or reinforcing scrims. However, it is very difficult to do so in the direction perpendicular to the planar dimension, i.e., the z-direction. Therefore, the high temperature gel processed insulative composite is robust and has a high tensile strength in the z-direction, referred to herein as “high z strength”. Furthermore, the high z-strength of the gel processed insulative composite reduces cohesive failure when bonded directly to the cell or other battery pack components and/or allows unique layering to other materials. Additionally, the gel processed insulative composite is non-particulating, and material does not slough off during assembly or in use. Table 2 is a tabular representation of the z-strength of the gel processed insulative composites and Comparative Example 1 (non-gel processed insulative composite).

In certain applications, such as in lithium-ion batteries, a high temperature thermal event may occur. The high temperature thermal event may be sufficient to damage adjacent lithium-ion battery cells and includes situations where exposure of the adjacent lithium-ion battery cells to the high temperature event may trigger a secondary high temperature event in adjacent lithium-ion battery cells (i.e., runaway events in failing lithium-ion batteries). As such, there is a need for an insulative barrier that protects adjacent lithium-ion battery cells from exposure to high (damaging) temperatures. As demonstrated in the assay described herein, one side (“challenge side”) of a thin sheet (approximately 1 mm thick) of a gel processed insulative composite was compressively contacted with an approximately 800° C. heated stainless steel mass. The average maximum temperature on the opposing side of the thin sheet (“protected side”) was significantly lower. In some embodiments, high temperature gel processed insulative composites capable of functioning as a heat propagation barrier are those capable of limiting the average maximum temperature on the protected side to 250° C. or less when the challenge side is exposed to a temperature of approximately 800° C. when following the Protective Heat Propagation Barrier Testing Assay described below.

High temperature gel processed insulative composites are those capable of providing at least about 70%, at least about 73%, at least about 75%, at least about 80%, at least about 85%, at least about 90% or at least about 95% (with 100% being the maximum or the total % equals 100%) reduction in observed maximum temperature (i.e., on the protected/insulated side) when subjected to a temperature (i.e., on the challenge side) of at least 500° C., preferably within a temperature range from about 500° C. to about 1200° C.

### Insulative Particles

The term “insulative particles” refers to insulative particles that include at least one of: fumed silica, amorphous silica, colloidal silica, precipitated silica, fused silica, silica gel, aerogels (such as silica-based aerogels), silica xerogel, silicates (such as calcium silicate), fumed metal oxides (such as fumed alumina, fumed titania, fumed blends of silica/alumina/titania), and combinations thereof. In some embodiments, the thermally insulative particles may be modified to contain functional groups to alter the relative hydrophilicity/hydrophobicity of the particles (e.g., fumed hydrophobic silica). In some embodiments, the insulative particles may consist solely of fumed silica particles. In some embodiments, aerogel particles (such as silica-based aerogels) may be present in the insulative particles but may not form the total amount of particles present in the insulative particles.

The amount of insulative particles present within the insulative composite may be at least about 50 wt % (based on the total weight of insulative particles), at least about 55 wt %, at least about 60 wt %, at least about 65 wt %, at least about 70 wt %, at least about 75 wt %, at least 80 wt %, at least about 85 wt %, at least about 90 wt %, at least about 95 wt %, or at least about 96 wt %. In some embodiments, the insulative particles are present within the insulative composite in an amount from about 50 wt % to about 96 wt %, from about 55 wt % to about 96 wt %, from about 60 wt % to about 96 wt %, from about 65 wt % to about 96 wt %, from about 70 wt % to about 96 wt %, from about 75 wt % to about 96 wt %, from about 80 wt % to about 96 wt %, from about 85 wt % to about 96 wt %, from about 90 wt % to about 96 wt %, or from about 93 wt % to about 96 wt %.

### Gel Processed Polymer Matrix

The use of a gel processed polymer matrix to create the high temperature insulative composites enables the formation of thin, strong, and flexible form factors (e.g., films, sheets, and tubes) having the insulative particles and other components distributed within the gel processed polymer matrix. The gel processed polymer matrix may be any polymer that can be processed by a gel process, such as, but not limited to, extrusion, injection molding, compression molding, and calendering. It is to be appreciated that there is no imbibing step to introduce the aerogel particle(s), reinforcement fiber(s), and/or other additional components into the gel processed polymer matrix. As discussed above, thin and flexible form factors are important in lithium-ion battery cells and modules.

In some embodiments, the high temperature gel processed insulative composites may have a thickness up to about 25 mm. The gel processed insulative composite may have a thickness from about 0.1 mm to about 2 mm, from about 0.5 mm to about 2 mm, from about 0.75 mm to about 2 mm, from about 1 mm to about 2 mm, from about 1.25 mm to about 2 mm, from about 1.5 mm to about 2 mm, from about 1.75 mm to about 2 mm, from about 0.1 mm to about 1 mm, from about 0.25 mm to about 1 mm, from about 0.5 mm to about 1 mm, or from about 0.75 mm to about 1 mm. In some embodiments, the high temperature gel processed insulative composite has a thickness from about 2 mm to about 4 mm, from about 2.25 mm to about 4 mm, from about 2.5 mm to about 4 mm, from about 2.75 mm to about 4 mm, from about 3 mm to about 4 mm, from about 3.25 to about 4 mm, from about 3.5 mm to about 4 mm. In some embodiments, the insulative composite has a thickness from about 4 mm to about 10 mm, from about 5 mm to about 10 mm, from about 6 mm to about 10 mm, from about 7 mm to about 10 mm, from about 8 mm to about 10 mm, or from about 9 mm to about 10 mm. In some embodiments, the gel processed insulative composite has a thickness from about 10 mm to about 25 mm, from about 15 mm to about 25 mm, from about 20 mm to about 25 mm. In some embodiments, the thickness of the high temperature insulative composite is greater than or equal to about 0.1 mm, greater than or equal to about 0.5 mm, less than or equal to about 1 mm, less than or equal to about 1.5 mm, less than or equal to 2 mm, less than or equal to 4 mm, less than or equal to 10 mm, less than or equal to 25 mm.

The gel processed polymer matrix may be prepared from any conventional gel processing. Non-limiting examples of gel processed polymers include polyethylene, UHMWPE, polypropylene, ethylene-propylene copolymers, polyoxymethylene, polyethylene oxide, polyamides, polyethyleneterephthalate, polyacrylonitrile, polyvinylalcohol, polylactic acid (PLA), polyhydroxyalkanoates, polyvinylidenefluoride, and combinations thereof.

In some embodiments, the gel processed polymer matrix is a gel processed polyethylene matrix having a number average molecular weight greater than about 200,000 g/mol, 500,000 g/mol, greater than about 1,000,000 g/mol, greater than about 1,500,000 g/mol, greater than about 2,000,000 g/mol, greater than about 2,500,000 g/mol, or greater than about 3,000,000 g/mol, or greater than about 5,000,000 g/mol, or greater than 8,000,000 g/mol, or greater than 10,000,000 g/mol, or even higher. The gel processed polymer matrix may range from about 200,000 g/mol to about 12,000,000 g/mol, from about 500,000 g/mol to about 12,000,000 g/mol, or from about 1,000.00 g/mol to about 12,000,000 g/mol, or from about 1,000,000 to about 10,000,000 g/mol. In some embodiments, the gel processed polymer may include a blend of various number average molecular weights of the gel processed polymer within the gel processed polymer matrix. In some embodiments, the blend includes being both high molecular weight (e.g., 3,000,000 g/mol) and low molecular weight (e.g., 200,000 g/mol) gel processed polyethylene. It is to be appreciated that any blend of number average molecular weight gel processed polyethylene matrix is within the purview of this disclosure.

The amount of gel processed polymer matrix present in the high temperature insulative composite is about 35 wt % or less, about 30 wt % or less, about 25 wt % or less, about 20 wt % or less, about 15 wt % or less, about 10 wt % or less, about 7 wt % or less, about 5 wt % or less, or about 4 wt % or less. The gel processed polymer matrix may be present in the high temperature insulative composite in an amount from about 1 wt % to about 35 wt %, from about 1 wt % to about 30 wt %, from about 1 wt % to about 25 wt %, from about 1 wt % to about 20 wt %, from about 1 wt % to about 15 wt %, from about 1 wt % to about 10%, from about 1 wt % to about 5 wt %, or from about 1 wt % to about 4 wt % In other embodiments, the amount of gel processed polymer matrix ranges from about 0.5 wt % to about 20 wt %, from about 0.5 wt % to about 15 wt %, from about 0.5 wt % to about 10 wt %, from about 0.5 wt % to about 5 wt %, or from about 0.5 wt % to about 4 wt %.

The high temperature insulative composite can be formed into relative thin form factors (e.g., sheets). Thin form factors of the high temperature insulative composite are attractive for use in electronic devices and/or batteries where an undesirable high temperature thermal event may occur. In one embodiment, the high temperature insulative composite may be formed into any extrudable profile or article or injection molded shape or molded article. One non-limiting example includes a cylindrical cell battery holder.

### Additional Components

The insulative composite may further include one or more additional components in an amount less than about 35 wt %. In some embodiments, the additional components are present in the gel processed insulative composite in an amount less than about 30 wt %, less than about 25 wt %, less than about 20 wt %, less than about 15 wt %, less than about 10 wt %, or less than about 5 wt %. In some embodiments, the additional components may be present in an amount from about 5 wt % to about 35 wt %, from about 5 wt % to about 30 wt %, from about 10 wt % to about 25 wt %, from about 10 wt % to about 20 wt %, from about 5 wt % to about 20 wt %, or from about 5 wt % to about 15 wt %. Non-limiting additional components include, but not limited to, flame retardant materials, additional polymers, opacifier(s) (as discussed below), reinforcement fiber(s) (as discussed below) antioxidant(s), intumescent material(s), oxygen scavenger(s), dyes, plasticizers, and thickeners.

### Opacifiers

In some embodiments, the insulative composite includes at least one opacifier. Opacifiers reduce radiative heat transfer and improve thermal performance. Non-limiting examples of suitable opacifiers for use in the insulative composite include, but are not limited to, carbon black, titanium dioxide, aluminum oxide, zirconium dioxide, iron oxides, silicon carbide, molybdenum silicide, manganese oxide, a polydialkylsiloxane where the alkyl groups contain 1 to 7 carbon atoms, or any combination thereof. In some embodiments, the opacifier may be used in the form of a finely dispersed powder. In at least one embodiment, the amount of opacifier present in the high temperature insulative composite (based on the total weight of the insulative composite) is up to about 35 wt %, up to about 30 wt %, up to about 25 wt %, up to about 20 wt %, up to about 15 wt %, up to about 10 wt %, or up to about 5 wt %. In some embodiments, the opacifier(s) is present in the insulative composite (based on the total weight of the insulative composite) in an amount less than equal to 20 wt %. In some embodiments, the amount of opacifier(s) present in the high temperature gel processed insulative composite (based on the total weight of the gel processed insulative composite) may be from about 5 wt % to about 35 wt %, from about 5 wt % to about 30 wt %, from about 5 wt % to about 25 wt %, from about 5 wt % to about 20 wt %, from about 5 wt % to about 15 wt %, or from about 5 wt % to about 10 wt %.

### Reinforcement Fiber

In some embodiments, the high temperature insulative composite also includes at least one reinforcement fiber. In one embodiment, the reinforcement fiber may be chopped fibers having a size from about 0.1 mm to about 25 mm, from about 0.1 to about 19 mm, from about 0.1 mm to about 15 mm, from about 0.1 mm to about 13 mm, from about 0.1 mm to about 10 mm, from about 0.1 mm to about 7 mm, or from about 0.1 mm to about 5 mm. A variety of reinforcement fibers may be used and may include fibers such as, but not limited to, carbon fibers, glass fibers, aluminoborosilicate fibers, or combinations thereof. In some embodiments, the reinforcement fibers are chopped glass fibers. The amount of reinforcement fibers present in the high temperature insulative composite may be up to about 25 wt %. In some embodiments, the reinforcement fiber is present in an amount from about 1 wt % to about 25 wt %, from about 2 wt % to about 20 wt %, from about 3 wt % to about 20 wt %, from about 5 wt % to about 15 wt %, from about 8 wt % to about 15 wt %, from about 9 wt % to about 15 wt %, or from about 10 wt % to about 15 wt %. In some embodiments, the reinforcement fiber is present in an amount from about 1 wt % to about 10 wt %, from about 2 wt % to about 10 wt %, from about 3 wt % to about 10 wt %, from about 4 wt % to about 10 wt %, from about 5 wt % to about 10 wt %, from about 6 wt % to about 10 wt %, from about 7 wt % to about 10 wt %, or from about 8 wt % to about 10 wt %. In some embodiments, the reinforcement fiber(s) may be present in the insulative composite in an amount from about 2 wt % to 10 wt %, from about 3 wt % to about 10 wt %, from about 4 wt % to about 10 wt %, from about 5 wt % to about 9 wt %, or from about 6 wt % to about 9 wt %.

### Mechanical Performance

### Z-Strength

The insulative composite described herein is not only a protective heat propagation barrier when subjected to a high temperature event, the insulative composite also possesses mechanical properties superior to comparative insulative materials. One such property includes a z-strength greater than about 25 N. In some embodiments, the z-strength of the insulative composite is greater than about 25 N, greater than about 30 N, greater than about 35 N, greater than about 40 N, greater than about 45 N, greater than about 50 N, greater than about 55 N, greater than about 60 N, greater than about 65 N, greater than about 70 N, or greater than about 75 N, or greater than about 100 N, or greater than about 250 N. In some embodiments, the z-strength may range from about 25 N to about 1000 N, from about 25 N to about 750 N, from about 25 N to about 700 N, from about 25 N to about 600 N, from about 25 N to about 550 N, from about 30 N to about 1000 N, from about 35 N to about 1000 N, from about 40 N to about 1000 N, from about 45 N to about 1000 N, from about 50 N to about 1000 N, from about 55 N to about 1000 N, from about 60 N to about 1000 N, from about 65 N to about 1000 N, or from 70 N to about 1000 N. In some embodiments, the z-strength may range from about 25 N to about 750 N, from about 25 N to about 700 N, from about 25 N to about 650 N, from about 25 N to about 600 N, or from about 25 N to about 550 N.

### Compressibility

Another mechanical property possessed by the insulative composite is compressibility. In some embodiments, the compressibility is less than about 35% at 1 MPa. The compressibility may range from about 1% to about 35% at 1 MPa, from about 1% to about 30% at 1 MPa, from about 1% to about 25% at 1 MPa, from about 1% to about 20% at 1 MPa, from about 1% to about 15% at 1 MPa, from about 1% to about 10% at 1 MPa, from about 1% to about 9% at 1 MPa, from about 1% to about 8% at 1 MPa, from about 1% to about 7% at 1 MPa, from about 1% to about 6% at 1 MPa, from about 1% to about 5% at 1 MPa.

### Average Maximum Temperature

The insulation composite has an average maximum temperature less than about 250° C., less than about 240° C., less than about 230° C., less than about 220° C., less than about 210° C., less than about 200° C., less than about 175° C., less than about 150° C., or less than about 125° C. The average maximum temperature may range from about 200° C. to about 250° C., from about 200° C. to about 240° C., from about 200° C. to about 230° C., from about 200° C. to about 225° C., from about 200° C. to about 210° C.; from about 215° C. to about 250° C., from about 215° C. to about 240° C., from about 215° C. to about 230° C., or from about 215° C. to about 220° C.

In some embodiments, the gel processed insulative composite includes an average maximum temperature less than 250° C., a Z-strength greater than 25 N, a compressibility less than 35% at 1 MPa.

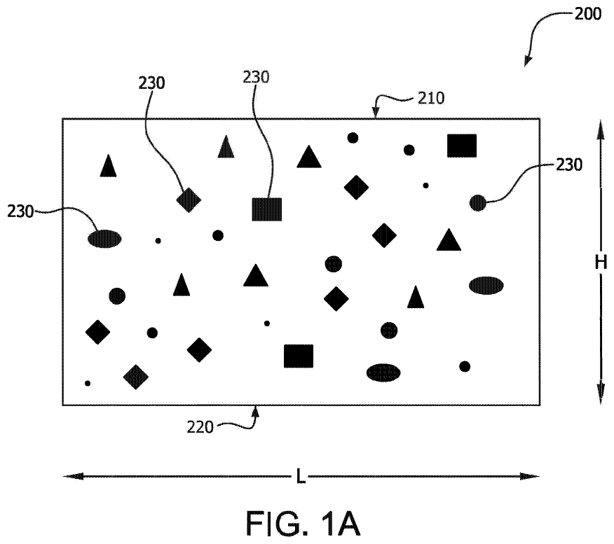

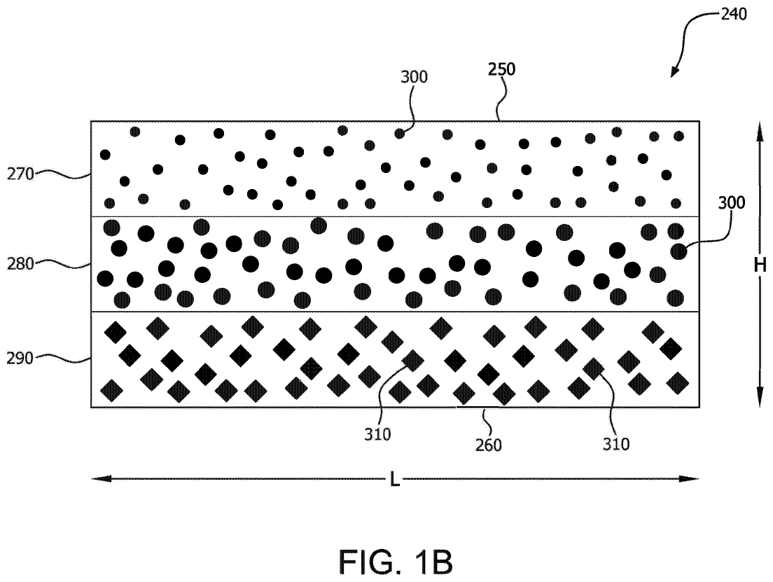

In some embodiments, the insulative particles and additional components of the high temperature insulative composite may be located through the thickness of the gel processed polymer matrix. As illustrated in FIG. 1A, the particulate components 230 are located fairly equally throughout the microstructure of the gel processed polymer matrix (membrane) of the high temperature insulative composite 200. The high temperature insulative composite 200 has a challenge side 210, a protected side 220, a height (H) and a length (L). It is to be appreciated that, in some embodiments (not illustrated), the insulative particles and additional materials may be located on a surface of the insulative composite.

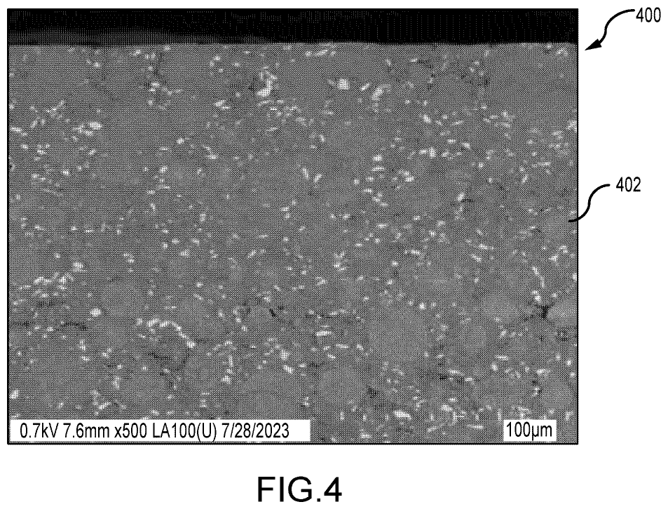

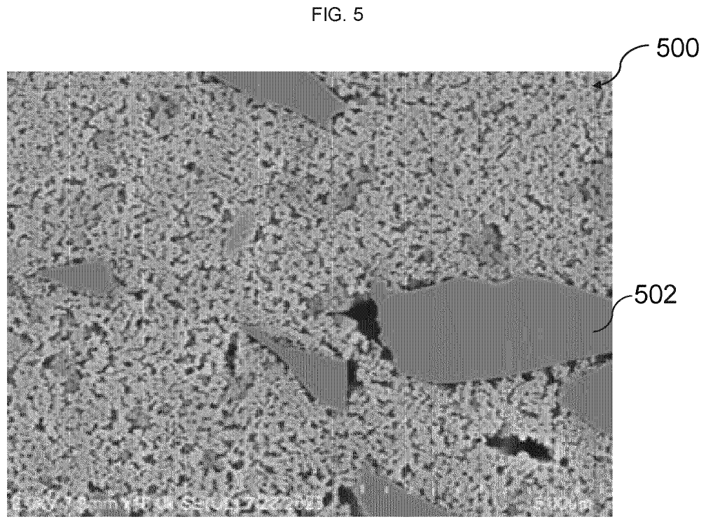

The insulative composite may be formed of a composite (e.g., one layer) as generally depicted in FIG. 1A or optionally as a multi-layer stack high temperature insulative composite (e.g., multiple, individual layers) as generally depicted in FIG. 1B. In a multi-layer stack high temperature insulative composite, each layer may have therein a particulate that has a different chemical composition, a different particle size, a different particle size distribution, or a different particle distribution. In one embodiment, opacifiers having differing properties such as composition, size, and/or shape may be distributed in various layers throughout the thickness of the high temperature insulative composite, such as is described in Hu et al. (Radiative Characteristics of Opacifier Loaded Silica Aerogel Composites, 2013). FIG. 4 is a scanning electron micrograph (SEM) of a cross-section of a gel processed insulative composite 400 showing opacifier particles 402 distributed throughout the gel processed insulative composite 400. FIG. 5 is an SEM of a portion of the SEM of FIG. 4. As shown in FIG. 5 including a blown-up view of the SEM of FIG. 4, opacifier particles 502 are distributed throughout the gel processed insulative composite 500.

In the multi-layer stack high temperature insulative composite illustrated in FIG. 1B, for ease of illustration, of the particulate components present in the multi-layer stack high temperature insulative composite, only the opacifiers are depicted. FIG. 1B is a schematic cross-section of one embodiment of a multi-layer stack high temperature insulative composite having multiple layers. As shown, the multi-layer stack high temperature insulative composite 240 has a height (H) and a length (L). The multi-layer stack high temperature insulative composite 240 contains a challenge side 250 and a protected side 260.

In the embodiment depicted in FIG. 1B, the height (H) is divided into three layers, namely Layer A 270, Layer B 280, and Layer C 290. In some embodiments, Layer A 270, Layer B 280, and Layer C 290 may contain the same type of opacifier but with different size distributions. In other embodiments, Layer A 270, Layer B 280, and Layer C 290 may contain different types of opacifier with different size distributions. As shown in FIG. 1B, Layer A 270 has a first opacifier 300 with a first size distribution, Layer B 280 has a first opacifier 300 with a second size distribution, and Layer C 290 has a second opacifier 310 with the first size distribution. The first opacifier 300 may be silicon carbide and the second opacifier 310 may be carbon black, although this is exemplary in nature and is not meant to restrict the purview of this disclosure. In some embodiments, the particulate components themselves may be different in each layer, or only in certain layers. In other embodiments, the particulate components are the same in each layer, but each layer has a different size distribution. Thus, each layer in a multi-layer stack high temperature insulative composite may include one or more particulate components(s) that have a different chemical composition, a different particle size, and/or a different particle size distribution within each layer (or only within certain layers).

In forming a multi-layer stack high temperature insulative composite, each layer is separately formed as described below and then layered or stacked upon each other in a manner to obtain a desired orientation of the layers in the multi-layer stack high temperature insulative composite. The layers may be bound to each other in any conventional manner such as laminating, adhering, or other bonding techniques to form a multi-layer high temperature insulative composite.

### Articles Including A High Temperature Insulative Composite

In one embodiment, a thermally insulative article includes a first component that is capable of generating a high temperature event (i.e., a first temperature), a second component to be protected against exposure to the first temperature caused by the high temperature event, and a high temperature gel processed insulative composite. The high temperature gel processed insulative component is positioned between the first component and the second component. The high temperature insulative component may be in the form of a sheet, film or tape. A first side of the high temperature gel processed insulative component may be oriented toward the first component and a second side of the high temperature gel processed insulative component may be oriented toward the second component.

The thermally insulative article may also include one or more support materials in the form of supportive layer(s) on one or more sides of the high temperature insulative composite. In one embodiment, the support layer(s) is a polymer layer, a woven layer, a knit layer, a non-woven layer, or any combination thereof. The polymer layer can be a nonporous layer, a porous layer, a microporous layer, and any combination thereof. Non-limiting additional support layers include a fluoropolymer membrane (e.g., polytetrafluoroethylene membrane), an expanded fluoropolymer membrane (e.g., expanded polytetrafluoroethylene membrane), a polyolefin membrane (e.g., polyethylene membrane), a metal film, electrical insulation, an adhesive layer, mica, or any combination thereof. Support layer(s) may be included in the thermally insulative article by laminating, adhering, or otherwise bonding one or more support layers to the high temperature insulative composite. For example, the high temperature insulative composite is may be in the form of a sheet or a film having a first side and a second side, where the thickness is less than the width and/or length directions. One or more support layers can be adhered to the first side, to the second side or to both the first and the second side of the high temperature insulative composite.

The one or more support layers can be adhered to the high temperature insulative composite using an adhesive, welding, calendering, coating, or any combination thereof. In some embodiments, the thermally insulative article can include multiple layers. For example, the high temperature insulative composite can have a layer of polyethylene bonded to one or both sides, resulting in a high temperature insulative composite having a 2-layer or a 3-layer structure. One or more textile layers, for example, a woven, a knit, a non-woven or any combination thereof, may be adhered to high temperature insulative composite. An adhesive may be applied to the high temperature insulative composite, to the textile or to both in a continuous or a discontinuous manner, as is well-known in the art.

The textile layer(s) can be a woven, a knit, a non-woven or any combination thereof. In some embodiments, the woven, knit or non-woven textile may be a flame resistant woven, a flame-resistant knit, or a flame-resistant non-woven textile. Suitable textile layers are well-known in the art and may include elastic and non-elastic textiles, such as, for example, LYCRA®, polyurethane, polyester, polyamide, acrylic, cotton, wool, silk, linen, rayon, flax, jute, flame resistant textiles, such as, for example, NOMEX® aramid (available from Du Pont, Wilmington, DE), aramids, flame resistant cotton, polybenzimidazole, poly p-phenylene-2,6-benzobisoxazole, flame resistant rayon, modacrylics, modacrylic blend, polyamine, carbon, fiberglass or any combination thereof.

### Lithium-Ion Battery

In some embodiments, the high temperature insulative composite is used as an insulative and protective barrier layer in a high energy battery such as a high energy multi-cell lithium-ion battery. In one aspect, the gel processed insulative composite is used to at least partially or fully enclose or separate one or more lithium-ion battery cells from each other. The thermal isolation the gel processed insulative composite creates stops or slows any thermal propagation of adjacent cells or modules. The high temperature insulative composite may also be used in module or pack insulation to prevent the propagation of thermal energy or the harmful effects of propagation that may occur when the thermal energy propagates to the opposing side of the high temperature gel processed insulative composite.

Other embodiments in which the high temperature insulative composite may be utilized include, but are not limited to, lithium cells used in electrification of aircraft and drones, lithium cells used for residential energy storage (e.g., solar or wind energy storage), lithium cells used for energy backup systems for buildings and critical infrastructure, cells used for computer power back-up systems or uninterruptable power systems (UPS), cells used in electric marine vehicles, drones, and unmanned aerial vehicle (UAV), cells used in personal vehicles (e.g., scooters), and cells used in emergency medical backup systems.

The disclosure of this application has been described above both generically and with regard to specific embodiments. It will be apparent to those skilled in the art that various modifications and variations of the disclosure can be made without departing from the spirit or scope of the disclosure, as defined in the appended claims.

### Test Methods

### Compressibility

Compressibility was measured using a method based on ASTM F36-15. The testing apparatus consisted of an Instron 5966 universal testing machine (Norwood, MA, USA) with an Instron T1223-1021-D penetrator (Norwood, MA, USA), C31209 Instron anvil (Norwood, MA, USA), and 10 kN load cell. The test specimen was a 1.5 in. diameter circle prepared by a die punch. A single test specimen was placed on the anvil and then compressed by the penetrator to a preload of 2 kPa. The thickness under preload (P) was recorded. A load was applied at a rate of 0.01 mm/s until a maximum load of 1 MPa was reached. The thickness under total load (M) was recorded. Compressibility was calculated according to ASTM F36-15 as follows:

Compressibility, %=[(P−M)/P]×100

### Thickness

Sample thickness was measured using a ProGauge Thickness Tester (Thwing-Albert Instrument Company, West Berlin, NJ) at a pressure of 50 kPa. The result of a single measurement was recorded.

### Protective Heat Propagation Barrier Assay

A stainless-steel block (“heat accumulator”), having the following dimensions: height 5.5 inches (approximately 13.97 cm); width 3.5 inches (approximately 8.89 cm); and thickness 0.5 inches (approximately 1.27 cm) was obtained. The heat accumulator exhibited a density of 7999.4 kg/m³, a volumetric heat capacity of 617.6 J/kgK, and a calculated sensible energy of 600 kJ. The side of the test material placed in contact with the heated stainless-steel block was referred to herein as the “challenge side”. The opposing side of the test material was referred to as the “protected side”. Two identical test samples (each approximately 1 mm thick) were placed on opposing sides of the rectangular heat accumulator that had been heated to a target temperature of 800° C. to ensure symmetric heat dissipation. Type K thermocouples were used to measure the temperature of the heat accumulator as well as the temperature on the opposing side of each test sample. The average temperature on the opposing side of each test sample was recorded continually over the test duration (time from 0 to 15 minutes) post contact with the heat accumulator and the maximum average temperature observed during the contact period was calculated and recorded.

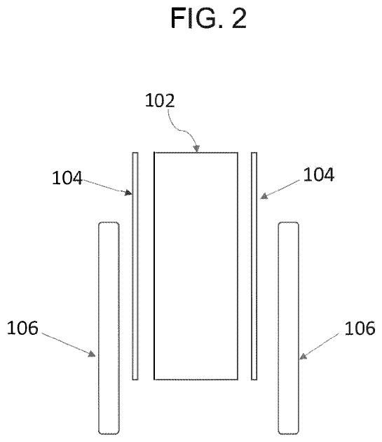

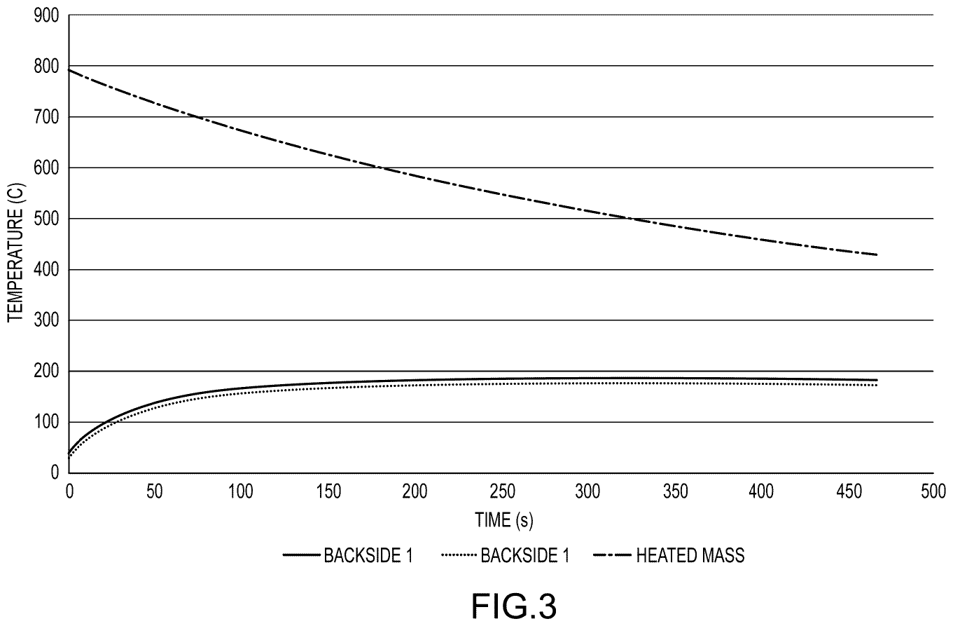

Looking at FIG. 2, to initiate a test, a heat accumulator 102 was heated to approximately 800° C. (e.g., in a furnace). Test samples 104 were paced on opposing sides of the heat accumulator 102. Type-K thermocouples 106 recorded the temperature on the opposite side of each test sample 104 were recorded over a defined time (from 0 min to 15 minutes). The maximum average temperate observed over the defined contact period was calculated and recorded. FIG. 3 is a graph illustrating a representative plot of the heat accumulator temperature and the temperature measured on the opposing sides of the composite insulation sample over test duration.

### Z-Strength

The cohesive strength of the composites was measured under ambient conditions using a TAPPI-541 (Zwick, Germany) device. A 75 mm×130 mm piece of two-sided adhesive tape, such as 9500PC (3M Corporation), was attached to similar sized face of the bottom platen. Composite samples were slit into 25.4 mm×25.4 mm shapes and placed over the tape covered bottom platen. The upper platen, which has identical five 25.4 mm×25.4 mm test areas, was covered with the same two-sided adhesive tape. The upper & bottom platens were mounted in an INSTRON® tensile testing machine (Model 5567; Illinois Tool Works Inc., Norwood, MA) with the two platens aligned at a 90 degree angle to each other. The platens with the sample in between were compressed together to 3.16 kN at a rate of 12.7 mm/min and held under that force for 30 seconds. The compressive force was then reduced to zero at a rate of 12.0 kN/min. After 7.5 seconds of force removal, the platens were separated at the rate of 50.8 mm/min and the maximum force, in Newtons, to separate the platen was recorded. If the failure is cohesive in nature, the failed sample would be covering the surfaces of both the platens. If the cohesive strength of the sample is greater than the adhesive strength of the tape to the platens or of the tape to the sample, both the platens will not be covered with failed portion of both the samples. Samples in each of the 5 test areas were measured as above and F_{avg}, the average of five maximum force values, was calculated.

### EXAMPLES

### Comparative Example 1—High Temperature Insulative Composite Prepared Using Paste-Processible Polymer (i.e. Non-Gel Processable Polymer Matrix)

A high temperature insulative composite was prepared using a paste-processible polymer (i.e. a non-gel-processed polymer matrix) according to Example 1, Sample 3 of U.S. Patent Appl. Publ. No. 2024-0258613 A1 to Fillery et al. Briefly, fibrillatable homopolymer polytetrafluoroethylene (PTFE) fine powder particles (12 wt %), 50 wt % aerogel particles (Cabot ENOVA™ silica aerogel; Cabot Corporation, Boston, MA), 30 wt % silicon carbide particles (opacifier) (F1200 Silicon carbide, Washington Mills North Grafton, Inc., North Grafton, MA), and 8 wt % chopped glass fibers (#30 E-Glass; ¼″ cut length (6.4 mm); fiber diameter 13 microns (Fibre Glast Developments Corp., Brookville, OH) were blended with a mineral spirit lubricant. The blend was then extruded and dried to form a high temperature insulative composite in the form of a sheet as generally taught in U.S. Pat. No. 7,868,083 to Ristic-Lehmann et al. The high temperature sheet had a thickness of approximately 1.04 mm and contained the fibrillatable PTFE particles, the aerogel particles, and the silicon carbide particles durably enmeshed and immobilized within the fibrillated PTFE matrix. The non-gel-processed insulative composite demonstrated an average maximum temperature of 172° C., a Z-strength of 14.6 N, and a compressibility of 40% (Table 2).

### Example 1—High Temperature Insulative Composite

A composite comprising 9 wt % gel-processed ultra-high molecular weight polyethylene particles (UHMWPE; molecular weight of about 4,600,000 g/mol) (STAMYLAN® UH210, DSM, The Netherlands), 65 wt % fumed silica particles (AEROSIL® 200, Evonik, Germany), 25.9 wt % silicon carbide particles (opacifier) (CARBOREX® FP1200 Silicon carbide, Washington Mills North Grafton, Inc., North Grafton, MA), and 0.05 wt % total antioxidants in equal parts (pentaerythritol tetrakis(3,5-di-tert-butyl-4-hydroxyhydrocinnamate) (IRGANOX® 1010) and tris(2,4-di-tert-butylphenyl) phosphite (IRGAFOS® 168), BASF, Germany) were blended in a mixer with mineral oil solvent (Crystal Plus Oil 500FG, STE Oil Company Inc., San Marcos, TX) to mixture ratio of 1.9:1 at room temperature (i.e., about 21° C.) to form a mixture (Table 1). The mixture was heated to a temperature of 165° C. and extruded through a die into the form of a tape using a counter-rotating twin screw extruder (BRABENDER® Twin Screw Mixer—TYPE 15-02-000, South Hackensack, NJ). Upon exiting the extruder, the tape was cooled to a temperature of about 70° C. using compressed air. The tape was then spooled onto a high-density polyethylene (HDPE) core.

The mineral oil in the cooled extruded tape was extracted from the tape while the tape was positioned on the HDPE core. The mineral oil extraction was completed by processing the tape through 3 sequential baths of low molecular weight isoparaffin (ISOPAR™ G, ExxonMobil Corp., Spring, TX). The tape remained in each bath for approximately 24 hours. After the third bath, the tape was allowed to air dry to remove any remaining isoparaffin and form a high insulative composite. The dried tape was then calendered to a final thickness.

The high temperature gel-processed insulative composite had a final thickness of approximately 1 mm and contained the gel processed polyethylene matrix (binder), fumed silica particles (insulative particles), and the silicon carbide particles (opacifier) in a cohesive composite structure. It is to be appreciated that all weight percentages were reported relative to the total weight of the final high temperature insulative composite. The gel processed insulative composite demonstrated an average maximum temperature of 178° C., a Z-strength of 488.8 N, and a compressibility of 5.1% (Table 2).

### Example 2—High Temperature Insulative Composite

A composite comprising 12 wt % gel-processed ultra-high molecular weight polyethylene particles (STAMYLAN® UH210, molecular weight of about 4,600,000 g/mol, DSM, The Netherlands), 71 wt % fumed silica particles (AEROSIL® 200, Evonik, Germany), 16 wt % silicon carbide particles (opacifier) (CARBOREX® FP1200, Washington Mills, Inc., North Grafton, MA), 1 wt % calcium stearate (Partek LUB CST, Sigma Aldrich, St. Louis, MO), and 0.05 wt % total antioxidants in equal parts (pentaerythritol tetrakis(3,5-di-tert-butyl-4-hydroxyhydrocinnamate) (IRGANOX® 1010) and tris(2,4-di-tert-butylphenyl) phosphite (IRGAFOS® 168), BASF, Germany) were blended in a mixer with mineral oil solvent (Crystal Plus Oil 500FG, STE Oil Company Inc., San Marcos, TX) at a mixture ratio of 2.2:1 at room temperature (i.e., about 21° C.) to form a mixture (Table 1). The mixture was heated to a temperature of 165° C., and gel extruded through a die into the form of a tape using a co-rotating twin screw extruder (Leistritz Extrusionstechnik GmbH, Nurnberg, Germany). Upon exiting the extruder, the tape was cooled to a temperature of about 70° C. using compressed air and spooled onto a plastic core. The tape was then calendered to the desired thickness.

After calendaring, the mineral oil in the cooled extruded tape was extracted while the tape was positioned on the plastic core. The mineral oil extraction was completed by allowing the tape to rest for 24 hours through 3 sequential baths of clean isoparaffin (ISOPAR™ G, ExxonMobil Corp., Spring, TX). After the third bath the tape was dried in an oven at a temperature of 110° C. to remove the isoparaffin and form a high temperature insulative composite.

The gel-processed high temperature insulative composite had a final thickness of approximately 1 mm and contained the gel-processed polyethylene matrix (binder), fumed silica particles (insulative particles), silicon carbide particles (opacifier), and calcium stearate and antioxidants in a cohesive composite structure. The gel-processed insulative composite demonstrated an average maximum test temperature of 160° C., a Z-strength of 817.1 N, and a compressibility of 11% (Table 2).

### Example 3—High Temperature Insulative Composite

A composite comprising 12 wt % gel-processed ultra-high molecular weight polyethylene particles (STAMYLAN® UH210, molecular weight of about 4,600,000 g/mol, DSM, The Netherlands), 71 wt % silica aerogel particles (Cabot ENOVA™ silica aerogel particles, Cabot Corp., Billerica, MA), 16 wt % silicon carbide particles (opacifier) (CARBOREX® FP1200, Washington Mills, Inc., North Grafton, MA), 1 wt % calcium stearate (Partek LUB CST, Sigma Aldrich, St. Louis MO), and 0.05 wt % total antioxidants in equal parts (pentaerythritol tetrakis(3,5-di-tert-butyl-4-hydroxyhydrocinnamate) (IRGANOX® 1010) and tris(2,4-di-tert-butylphenyl) phosphite (IRGAFOS® 168) BASF, Germany), were blended in a mixer were with isoparaffin mineral oil solvent (ISOPAR™ V, Exxon Mobil Corp., Spring, TX) to mixture ratio of 2.05:1 at room temperature (i.e., about 21° C.) to form a mixture (Table 1). The mixture was heated to a temperature of 165° C. and extruded through a die into the form of a tape using a co-rotating twin screw extruder (Leistritz Extrusionstechnik GmbH, Nurnberg, Germany). Upon exiting the extruder the tape was cooled to a temperature of about 70° C. using compressed air and spooled onto a plastic core.

The mineral oil in the cooled extruded tape was extracted while the tape was positioned on the plastic core. The mineral oil extraction was completed by allowing the tape to rest for 24 hours through 3 sequential baths of clean isoparaffin (ISOPAR™ G, ExxonMobil Corp., Spring, TX). After the third bath the tape was dried in an oven at a temperature of 110° C. to remove the isoparaffin and form a high temperature insulative composite.

The high temperature gel-processed insulative composite had a final thickness of approximately 1.1 mm and contained the gel processed polyethylene matrix (binder), silica aerogel particles (insulative particles), silicon carbide particles (opacifier), and calcium stearate and antioxidants in a cohesive composite structure. The gel processed insulative composite demonstrated an average maximum temperature of 193.0° C., a Z-strength of 499.3N, and a compressibility of 34% (Table 2).

### Example 4—High Temperature Insulative Composite Utilizing a Processing Lubricant and an Evaporative Solvent

A composite comprising 12 wt % ultra-high molecular weight polyethylene particles (STAMYLAN® UH210, molecular weight of about 4,600,000 g/mol, DSM, Netherlands), 71 wt % fumed silica particles (AEROSIL® 200, Evonik, Germany), 16 wt % silicon carbide particles (opacifier) (CARBOREX® FP1200, Washington Mills, Inc., North Grafton, MA), 1 wt % calcium stearate (Partek LUB CST, Sigma Aldrich, St. Louis, MO), and 0.05 wt % total antioxidants in equal parts (pentaerythritol tetrakis(3,5-di-tert-butyl-4-hydroxyhydrocinnamate) (IRGANOX® 1010) and tris(2,4-di-tert-butylphenyl) phosphite (IRGAFOS® 168) BASF, Germany) were blended in a mixer were with isoparaffin mineral oil solvent (ISOPAR™ M, ExxonMobil Corp., Spring, TX) to mixture ratio of 2.5:1 at room temperature (i.e., about 21° C.) to form a mixture (Table 1). The mixture was heated to a temperature of 165° C. and extruded through a die into the form of a tape using a co-rotating twin screw extruder (Leistritz Extrusionstechnik GmbH, Nurnberg, Germany). Upon exiting the extruder, the tape was cooled to a temperature of about 70° C. using compressed air and spooled onto a plastic core.

The ISOPAR™ M in the cooled extruded tape was then removed from the tape by passing it through an oven at 110° C. to remove any remaining isoparaffin and form a high temperature insulative composite.

The high temperature gel-processed insulative composite had a final thickness of approximately 1.1 mm and contained the gel processed polyethylene matrix (binder), fumed silica particles (insulative particles), silicon carbide particles (opacifier), and calcium stearate in a cohesive composite structure. The gel-processed insulative composite demonstrated an average maximum temperature of 192.5° C., a Z-strength of 546.5 N, and a compressibility of 8.0% (Table 2).

### Example 5—High Temperature Insulative Composite-Utilizing a Processing Lubricant and Leaving Residual Processing Oil

A composite comprising 12 wt % gel-processed ultra-high molecular weight polyethylene particles (STAMYLAN® UH210, molecular weight of about 4,600,000 g/mol, DSM, The Netherlands), 72 wt % fumed silica particles (AEROSIL® 200, Evonik, Germany), 16 wt % silicon carbide particles (opacifier) (CARBOREX® FP1200, Washington Mills, Inc., North Grafton, MA), and 0.05 wt % total antioxidants in equal parts (pentaerythritol tetrakis(3,5-di-tert-butyl-4-hydroxyhydrocinnamate) (IRGANOX® 1010) and tris(2,4-di-tert-butylphenyl) phosphite (IRGAFOS® 168) BASF, Germany) were blended in a mixer with mineral oil solvent (Crystal Plus Oil 500FG, STE Oil Company Inc., San Marcos, TX) at a mixture ratio of 2.2:1 at room temperature (i.e., about 21° C.) to form a mixture (Table 1). The mixture was heated to a temperature of 165° C., and gel extruded through a die into the form of a tape using a co-rotating twin screw extruder (Leistritz Extrusionstechnik GmbH, Nurnberg, Germany). Upon exiting the extruder, the tape was cooled to a temperature of about 70° C. using compressed air and spooled onto a plastic core. The tape was then calendered to the desired thickness.

The mineral oil in the cooled extruded tape was extracted while the tape was positioned on the plastic core. The mineral oil extraction was completed by allowing the tape to rest for 24 hours through 2 sequential baths of clean isoparaffin (ISOPART G, ExxonMobil Corp., Spring, TX). After the third bath the tape was dried in an oven at a temperature of 110° C. to remove the isoparaffin and form a high temperature insulative composite.

The high temperature gel processed insulative composite had a final thickness of approximately 1 mm and contained the gel processed polyethylene matrix (binder), fumed silica particles (insulative particles), silicon carbide particles (opacifier) in a cohesive composite structure. The gel processed insulative composite demonstrated an average maximum temperature of 218° C., a z-strength of 708.3 N, and a compressibility of 18% (Table 2).

### Example 6—High Temperature Insulative Composite-Utilizing a Processing Lubricant, an Evaporative Solvent, and a Flame Retardant (FR)

### Additive

A composite comprising 12 wt % gel-processed ultra-high molecular weight polyethylene particles (STAMYLAN® UH210, molecular weight of about 4,600,000 g/mol, DSM, Netherlands), 69 wt % fumed silica particles (AEROSIL® 200, Evonik, Germany), 15 wt % silicon carbide particles (opacifier) (CARBOREX® FP1200, Washington Mills, Inc., North Grafton, MA), 3 wt % flame retardant (FR Additive) (Melapur 200, BASF, Florham Park, NJ), 1 wt % calcium stearate (Partek LUB CST, Sigma Aldrich, St. Louis MO), and 0.05 wt % total antioxidants in equal parts (pentaerythritol tetrakis(3,5-di-tert-butyl-4-hydroxyhydrocinnamate) (IRGANOX® 1010) and tris(2,4-di-tert-butylphenyl) phosphite (IRGAFOS® 168) BASF, Germany) were blended in a mixer with mineral oil solvent (Crystal Plus Oil 500FG, STE Oil Company Inc., San Marcos, TX) at a mixture ratio of 2.45:1 at room temperature (i.e., about 21° C.) to form a mixture (Table 1). The mixture was heated to a temperature of 165° C., and gel extruded through a die into the form of a tape using a co-rotating twin screw extruder (Leistritz Extrusionstechnik GmbH, Nurnberg, Germany). Upon exiting the extruder, the tape was cooled to a temperature of about 70° C. using compressed air and spooled onto a plastic core.

The ISOPAR™ M in the cooled extruded tape was then removed from the tape by passing it through an oven at 110° C. to remove any remaining isoparaffin and form a high temperature insulative composite.

The high temperature gel processed insulative composite had a final thickness of approximately 1.0 mm and contained the gel processed polyethylene matrix (binder), fumed silica particles (insulative particles), silicon carbide particles (opacifier), FR Additive, and Calcium Stearate in a cohesive composite structure. The gel processed insulative composite demonstrated an average maximum temperature of 185° C., a z-strength of 338.1 N, and a compressibility of 12% (Table 2).

### Example 7 (PROPHETIC) —High Temperature Insulative Composite-Utilizing a Processing Lubricant, an Evaporative Solvent, and a Blend of Different Silica Types

A composite comprising 12 wt % gel-processed ultra-high molecular weight polyethylene particles (STAMYLAN® UH210, molecular weight of about 4,600,000 g/mol, DSM, Netherlands), 56.8 wt % fumed silica particles (AEROSIL® 200, Evonik, Germany), 14.2 wt % precipitated silica particles (SIPERNAT® 22 S, Evonik, Germany), 16 wt % silicon carbide particles (opacifier) (CARBOREX® FP1200 Silicon carbide, Washington Mills North Grafton, Inc., North Grafton, MA), and <0.1 wt % antioxidant (IRGANOX® 1010, BASF, Germany), and 1 wt % calcium stearate as a processing lubricant (Partek LUB CST, Sigma Aldrich, St. Louis MO and source) are blended in a mixer with paraffinic mineral oil solvent (ISOPAR™ M, ExxonMobil Corp., Spring, TX) to mixture ratio of 2.5:1 at room temperature (i.e., about 21° C.) to form a mixture. The mixture is heated to a temperature of 165° C., and is extruded through a die into the form of a tape using a counter rotating twin screw extruder (BRABENDER® Twin Screw Mixer—TYPE 15-02-000, South Hackensack, NJ). Upon exiting the extruder the tape is cooled to a temperature of about 70° C. using compressed air. The tape is then spooled onto a polyvinyl chloride (PVC) core.

The ISOPAR™ M in the cooled extruded tape is then removed from the tape by passing it through an oven at 110° C. to remove any remaining isoparaffin and form a high temperature insulative composite.

The high temperature gel processed insulative composite is then calendared to a final thickness of approximately 1.2 mm. The high temperature gel processed insulative composite contains the gel processed polyethylene matrix (binder), fumed and precipitated silica particles (insulative particles), silicon carbide particles (opacifier), and residual calcium stearate in a cohesive composite structure.

It is to be appreciated that all weight percentages were reported relative to the total weight of the final high temperature insulative composite. The gel processed insulative composite is then tested to determine the average maximum temperature, a z-strength, and compressibility.

TABLE 1
Weight Percent of Components in High Temperature Insulative Compositions

| Material | Example 1 | Example 2 | Example 3 | Example 4 | Example 5 | Example 6 |
|---|---|---|---|---|---|---|
| Fumed | 65% | 71% | | 71% | 72% | 69% |
| silica | | | | | | |
| Silica | | | 71% | | | |
| aerogel | | | | | | |
| Silicon | 26% | 16% | 16% | 16% | 16% | 15% |
| Carbide | | | | | | |
| UHMWPE | 9% | 12% | 12% | 12% | 12% | 12% |
| FR additive | | | | | | 3% |
| Calcium | | 1% | 1% | 1% | | 1% |
| stearate | | | | | | |
| IRGAFOS ® | 0.025% | .025% | 0.025% | 0.025% | 0.025% | 0.025% |
| 168 | | | | | | |
| IRGANOX ® | 0.025% | 0.025% | 0.025% | 0.025% | 0.025% | 0.025% |
| 1010 | | | | | | |

TABLE 2
Properties of High Temperature Insulative Compositions

| | Maximum Test | | Compressibility at |
|---|---|---|---|
| Example | Temperature (° C.) | Z-Strength (N) | 1 MPa (%) |
| 1 | 178 | 488.8 | 5.1 |
| 2 | 160 | 817.1 | 11 |
| 3 | 193 | 499.3 | 34 |
| 4 | 193 | 546.5 | 8.0 |
| 5 | 218 | 708.3 | 18 |
| 6 | 185 | 338.1 | 12 |
| Comparative | 172 | 14.6 | 40 |
| Example 1 | | | |

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

1. An insulative composite comprising:
greater than about 50 wt % of insulative particles;
less than about 35 wt % of a gel processed polymer matrix; and
less than about 35 wt % of a combined total of additional components,
wherein the weight percent is based on the total weight of the final insulative composite, and
wherein the insulative composite has at least one of an average maximum temperature less than about 250° C., a Z-strength greater than about 25 N, and a compressibility less than about 35% at 1 MPa.

2. The insulative composite of claim 1, wherein the insulative particles are selected from fumed silica, amorphous silica, colloidal silica, precipitated silica, fused silica, silica gel, silica xerogel, aerogels, silica aerogels, silicates, fumed metal oxides, and combinations thereof.

3.-4. (canceled)

5. The insulative composite of claim 1, wherein the gel processed polymer matrix comprises a gel processed polymer selected from polyethylene, polypropylene, ethylene-propylene copolymers, polyoxymethylene, polyethylene oxide, polyamides, polyethyleneterephthalate, polyacrylonitrile, polyvinylalcohol, polyhydroxyalkanoates (PHAs), polylactic acid (PLA), and polyvinylidenefluoride.

6. The insulative composite of claim 1, wherein the gel processed polymer matrix comprises a gel processed polyethylene (PE) having a number average molecular weight greater than about 500,000 g/mol, optionally wherein the gel processed polymer matrix comprise less than about 20 wt % of the insulative composite.

7. (canceled)

8. The insulative composite of claim 1, wherein the insulative composite is non-particulating.

9. The insulative composite of claim 1, wherein a total of the additional components comprise one or more opacifier, one or more antioxidant, one or more reinforcement fiber, or any combination thereof, optionally wherein the opacifier is selected from carbon black, titanium dioxide, aluminum oxide, zirconium dioxide, iron oxides, silicon carbide, molybdenum silicide, manganese oxide, a polydialkylsiloxane where the alkyl groups contain 1 to 7 carbon atoms, or any combination thereof.

10.-11. (canceled)

12. The insulative composite of claim 1, wherein the gel processed polymer matrix comprises a blend of at least two different number average molecular weights of the gel processed polymer.

13. The insulative composite of claim 1, wherein the insulative composite is in the form of an extruded profile, extruded article, injection molded shape, or injection molded article, optionally wherein the insulative composite comprises at least one support layer directly bonded thereto.

14. (canceled)

15. The insulative composite of claim 1, wherein the insulative particles and additional components are present through a thickness thereof, or wherein particulate components are present through a thickness thereof.

16. (canceled)

17. An article comprising the insulative composite of claim 1.

18. (canceled)

19. A multilayer article comprising at least two layers of the insulative composite of claim 1, optionally wherein the at least two layers each comprise different components therein.

20. (canceled)

21. An article comprising:
a first component capable of a generating a high temperature event comprising a first temperature;
a second component to be protected against exposure to the first temperature; and
an insulative composite positioned between the first component and the second component, the insulative composite having a first side oriented toward the first component and an opposing side oriented towards the second component; the insulative composite comprising:
greater than about 50 wt % of insulative particles;
less than about 35 wt % of a gel processed polymer matrix; and
less than about 35 wt % of a combined total of additional particulate components,
wherein the weight percent is based on the total weight of the final insulative composite, and
wherein the insulative composite includes at least one of an average maximum temperature less than about 250° C., a Z-strength of at least about 25 N, and a compressibility of less than about 35% at 1 MPa.

22. The article of claim 21, wherein the temperature on an external side of the second component is less than 250° C. at 50 kPa compression.

23. The article of claim 21, wherein the gel processed polymer matrix comprises a gel processed polymer selected from polyethylene, polypropylene, ethylene-propylene copolymers, polyoxymethylene, polyethylene oxide, polyamides, polyethyleneterephthalate, polyacrylonitrile, polyvinylalcohol, polyhydroxyalkanoates (PHAs), polylactic acid (PLA), and polyvinylidenefluoride, optionally wherein the gel processed polymer matrix comprises less than about 20 wt % of the insulative composite.

24. (canceled)

25. The article of claim 21, wherein the gel processed polymer matrix comprises an expanded gel processed polyethylene (PE) having a number average molecular weight greater than 500,000 g/mol.

26. The article of claim 21, wherein the gel processed polymer matrix comprises a blend of at least two different number average molecular weights of the gel processed polymer.

27. The article of claim 21, wherein the insulative particles are selected from fumed silica, amorphous silica, colloidal silica, precipitated silica, fused silica, silica gel, silica xerogel, aerogels, silica aerogels, silicates, fumed metal oxides, and combinations thereof.

28. (canceled)

29. The article of claim 21, wherein the additional particulate components comprise one or more opacifier, one or more antioxidant, one or more reinforcement fiber or any combination thereof.

30. (canceled)

31. The article of claim 21, wherein the insulative composite has a thickness less than about 25 mm, and wherein the article prevents thermal propagation in a lithium-ion battery.

32. (canceled)

33. The article of claim 21, comprising a support layer directly bonded to the insulative composite.

34. (canceled)
